(19) United States
(12) Patent Application Publication
(10) Pub. No.: US 2024/0425400 A1
(43) Pub. Date: Dec. 26, 2024

(54) METHOD OF SLUDGE PRETREATMENT FOR IMPROVED DIGESTIBILITY AND REDUCED SCALING

(71) Applicant: The Governors of the University of Alberta, Edmonton (CA)

(72) Inventors: Liu Yang, Edmonton (CA); Najiaowa Yu, Edmonton (CA); Lei Zhang, Edmonton (CA); Anqi Mou, Edmonton (CA); Huijuan Sun, Edmonton (CA); Abdulnayeem Mohammed, Edmonton (CA)

(73) Assignee: The Governors of the University of Alberta, Edmonton, AB (CA)

(21) Appl. No.: 18/290,853

(22) PCT Filed: Jul. 22, 2022
(86) PCT No.: PCT/CA2022/051138

§ 371 Date: Jan. 22, 2024

Related U.S. Application Data
(60) Provisional application No. 63/225,264, filed on Jul. 23, 2021.

(51) Int. Cl. C02F 11/145; A23K 10/10; A23K 50/80; C02F 3/12; C02F 11/00; C02F 11/04; C02F 101/10; C05F 7/00

(52) U.S. Cl. CPC C02F 11/145; A23K 10/10; A23K 50/80; C02F 3/12; C02F 11/004; C02F 11/04; C05F 7/00; C02F 2101/105

(57) ABSTRACT

A method of pretreating wastewater sludge including applying an amount of at least 0.01 g/g TSS Ca(ClO)₂ to wastewater sludge to enhance digestibility of the sludge and reduce phosphorus concentration therein and then allowing sufficient time for the wastewater sludge to densify to a treated sludge having a specific resistance to filtration (SRF) of 3 to 4 (10¹⁰ m/Kg). The resulting treated sludge composition being sterilized, free of harmful bacteria, and useful as a fertilizer, particularly for growing mushrooms.

### RELATED APPLICATIONS

This application claims priority benefit of U.S. Provisional Application Ser. No. 63/225,264 filed on Jul. 23, 2021, the contents of which are hereby incorporated by reference.

### FIELD OF THE INVENTION

The present invention relates to sludge treatment in centralized wastewater treatment plants (WWTP), and more particularly to a pretreatment for wastewater sludge that enhances the aerobic and anaerobic digestibility of sludge, enhances the methane yield, and eliminates downstream scaling problems.

### BACKGROUND OF THE INVENTION

Conventional activated sludge processes, as the main biological treatment approach for municipal wastewater treatment in centralized wastewater treatment plants (WWTP), generate a large amount of sludge, including primary sludge and waste activated sludge (WAS). The amount of sludge produced from WWTPs is proportional to the amount of wastewater treated. To provide a sense of scale, for the 5.8 billion cubic meters of municipal wastewater treated in WWTP in Canada, generated sludge is estimated to be 0.7 million dry tonnes (2.5 million wet tonnes) each year (Statistics Canada, 2019).

This generated sludge needs to be managed before disposal. Sludge management is technically difficult, costly and energy intensive, and represents ˜30-50% of a WWTP's operational cost. The key technology used in WWTPs for sludge management is sludge digestion (either anaerobic or aerobic). Sludge is composed of both primary sludge directly separated from primary wastewater settling, and secondary sludge (microbial cells from bioreactors). There are two key challenges associated with sludge digestion: (i) the digestibility of sludge is low, largely due to the low biodegradability of intracellular organic molecules (nucleic acids, proteins, carbohydrates, and lipids etc.) that are well protected by the cell structures and are hard to break; (ii) sludge digestion leads to the release of high concentrations of phosphorous, together with magnesium and ammonia, to the liquid phase which leads to the scaling of struvite (MgNH₃PO₄x6H₂O) in digesters, downstream pipes, pumps or centrifuges. In addition, the most common operating problems that cause unsatisfactory performances in a WWTP are sludge bulking and foaming issues.

Calcium Hypochlorite (Ca(ClO)₂), or bleaching powder as it is commonly known, is an inorganic compound often used to disinfect large volumes of water in order to make it safe to drink. It is also widely used in swimming pools to sanitize the water body and destroy the germs present in it. Previous studies have explored the use of Ca(ClO)₂ for treating waste activated sludge (WAS); however, these studies only focused on improving WAS fermentation performance with Ca(ClO)₂. However, the unimpeded anaerobic digestion involves both bacteria and archaea, with the later one extremely sensitive to oxidative stresses. Furthermore, three papers by a co-inventor, namely Zhu, X., Yang, Q., Li, X. et al. Enhanced dewaterability of waste activated sludge with Fe(II)-activated hypochlorite treatment. Environ Sci Pollut Res 25, 27628-27638 (2018). Luo, J., Huang, W., Zhang, Q., Guo, W., Wu, Y., Feng, Q., Fang, F., Cao, J., Su, Y. Effects of different hypochlorite types on the waste activated sludge fermentation from the perspectives of volatile fatty acids production, microbial community and activity, and characteristics of fermented sludge. Bioresource Technology, 307, 123227 (2020). Zhang, Q., Wu, Y., Luo, J., Cao, J., Kang, C., Wang, S., Li, K., Zhao, J., Aleem, M., Wang, D. Enhanced volatile fatty acids production from waste activated sludge with synchronous phosphorus fixation and pathogens inactivation by calcium hypochlorite stimulation. Science of The Total Environment, 712, 136500 (2020), reported the use of calcium hypochlorite for waste management (within or outside sludge management areas). These three papers evaluated the application of calcium hypochlorite for promoting sludge stability and recovering volatile fatty acids and focused on whether calcium hypochlorite can be used to improve the dewaterability and fermentation of WAS. The impact of Ca(ClO)₂ on anaerobic digestion of sludge, methane production, and reducing scaling has never been demonstrated nor reported.

Thus, there exists a need for a sludge treatment which not only enhances the aerobic and anaerobic digestibility of sludge, enhances the methane yield, reduces digester footprints, eliminates downstream scaling problem, helps mitigate the sludge foaming by filamentous bacteria, and reduces volatile solids (VS).

### SUMMARY OF THE INVENTION

The present invention provides a method of pretreating wastewater sludge that includes applying an amount of at least 0.01 g/g TSS Ca(ClO)₂ to wastewater sludge to enhance digestibility of the sludge and reduce phosphorus concentration therein and then allowing sufficient time for the wastewater sludge to densify to a treated sludge having a specific resistance to filtration (SRF) of 3 to 4 (10¹⁰ m/Kg). The resulting treated sludge composition being sterilized, free of harmful bacteria, and useful as a fertilizer, particularly for growing mushrooms.

### BRIEF DESCRIPTION OF THE DRAWINGS

The present invention is further detailed with respect to the following drawings that are intended to show certain aspects of the present invention but should not be construed as a limit on the practice of the present invention.

FIG. 1 is a graph showing Improved cell lysis, shown as soluble COD concentration increase after sludge pretreatment with Ca(ClO)₂ according to embodiments of the present invention;

FIG. 2 is a graph showing methane production for different-dosage treated sludge from CSTR after 240 days of operation, with error bars representing the standard deviations from triplicate experiments;

FIG. 3 is a graph showing methane yield from UASB reactors (mesophilic and thermophilic) treating sludge with and without the Ca(ClO)₂ pre-treatment according to embodiments of the present invention;

FIG. 4 is a graph showing methane content in the biogas generated from CSTR with different dosages of Ca(ClO)₂ pre-treatment according to embodiments of the present invention;

FIG. 5 is a graph showing effluent PO4-P concentration in mesophilic and thermophilic UASB reactors treating sludge with and without Ca(ClO)₂ pre-treatment according to embodiments of the present invention;

FIG. 6 is a photograph showing the formed granular sludge during the anaerobic digestion of sludge conditioned with 0.5 g Ca(ClO)₂/g TSS according to embodiments of the present invention;

FIG. 7 is a graph showing specific resistance to filtration (SRF) of sludge after Ca(ClO)₂ pretreatment according to embodiments of the present invention;

FIG. 8 is a photograph showing the decolouring effect of the inventive Ca(ClO)₂ pretreatment on sludge with the dosages ranging from 0-0.5 g Ca(ClO)₂/g TSS (from left to right);

FIGS. 9A-9E show fluorescence spectra of soluble microbial products in sludge after pretreatment with 0, 0.05, 0.1, 0.2, 0.5 g Ca(ClO)₂/g TSS Ca(ClO)₂ according to embodiments of the present invention; and

FIG. 10 shows a shear stress versus shear rate curve of WAS after pretreatment with 0, 0.05, 0.1, 0.2, 0.5 g Ca(ClO)₂/g TSS Ca(ClO)₂ according to embodiments of the present invention.

### DESCRIPTION OF THE INVENTION

The present invention has utility as a wastewater treatment sludge pretreatment which not only enhances the aerobic and anaerobic digestibility of sludge, enhances the methane yield, reduces digester footprints, eliminates downstream scaling problem, helps mitigate the sludge foaming by filamentous bacteria, and reduces volatile solids (VS).

The present invention will now be described with reference to the following embodiments. As is apparent by these descriptions, this invention can be embodied in different forms and should not be construed as limited to the embodiments set forth herein. Rather, these embodiments are provided so that this disclosure will be thorough and complete, and will fully convey the scope of the invention to those skilled in the art. For example, features illustrated with respect to one embodiment can be incorporated into other embodiments, and features illustrated with respect to a particular embodiment may be deleted from the embodiment. In addition, numerous variations and additions to the embodiments suggested herein will be apparent to those skilled in the art in light of the instant disclosure, which do not depart from the instant invention. Hence, the following specification is intended to illustrate some particular embodiments of the invention, and not to exhaustively specify all permutations, combinations, and variations thereof.

It is to be understood that in instances where a range of values are provided that the range is intended to encompass not only the end point values of the range but also intermediate values of the range as explicitly being included within the range and varying by the last significant figure of the range. By way of example, a recited range of from 1 to 4 is intended to include 1-2, 1-3, 2-4, 3-4, and 1-4.

Unless otherwise defined, all technical and scientific terms used herein have the same meaning as commonly understood by one of ordinary skill in the art to which this invention belongs. The terminology used in the description of the invention herein is for the purpose of describing particular embodiments only and is not intended to be limiting of the invention.

Unless indicated otherwise, explicitly or by context, the following terms are used herein as set forth below.

As used in the description of the invention and the appended claims, the singular forms “a,” “an” and “the” are intended to include the plural forms as well, unless the context clearly indicates otherwise.

Also as used herein, “and/or” refers to and encompasses any and all possible combinations of one or more of the associated listed items, as well as the lack of combinations when interpreted in the alternative (“or”).

As noted above, there are two key challenges associated with sludge digestion. First, the digestibility of sludge is low, largely due to the low biodegradability of intracellular organic molecules (nucleic acids, proteins, carbohydrates, and lipids etc.) that are well protected by the cell structures and are hard to break; and second, sludge digestion leads to the release of high concentrations of phosphorous, together with magnesium and ammonia, to the liquid phase which leads to the scaling of struvite (MgNH₃PO₄x6H₂O) in digesters, downstream pipes, pumps or centrifuges. The present invention addresses both of these challenges by pretreating sludge with Ca(ClO)₂ which not only enhances the digestibility of sludge, but also simultaneously fixes phosphorus as CaP to reduce phosphorus concentration in the liquid phase. Additionally, as a disinfecting metal salt, the Ca(ClO)₂ inventive pretreatment helps mitigate the sludge foaming by filamentous bacteria, and reduces volatile solids (VS) by converting organics to biogas in the following anaerobic digestion, thus alleviating the most common operating problem of sludge bulking and foaming that leads to unsatisfactory performance in a wastewater treatment plant (WWTP). Accordingly, the present invention, when used with the optimized chemical composition and dose and careful selection of the bioreactor type and operation mode, provides localized environment conditions that significantly improve the aerobic and anaerobic digestibility of sludge, enhance the methane yield, reduce digester footprints, eliminate downstream scaling problem of sludge treatment, and verified the potential of applying Ca(ClO)₂ pretreatment as an sludge reduction technology.

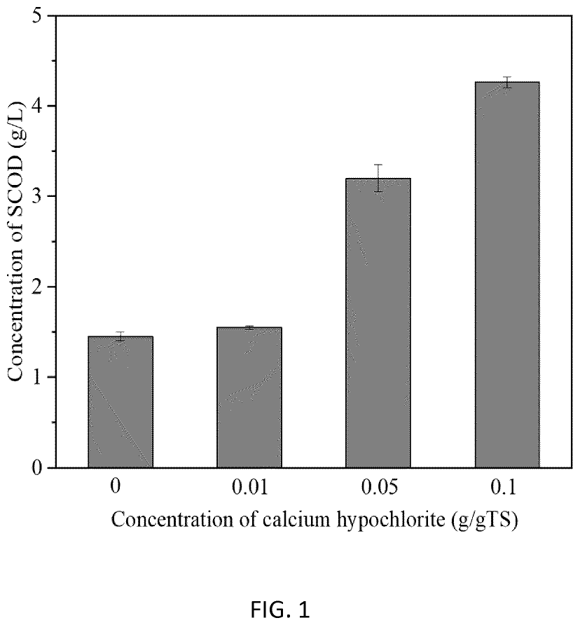

According to embodiments, the present invention provides a method of pretreating wastewater treatment sludge using Ca(ClO)₂. According to embodiments, the Ca(ClO)₂ is applied to the sludge either in the solid form (powder) or the emulsion form (dissolved in water). According to embodiments, the Ca(ClO)₂ is added directly to the secondary sludge transport pipes or to the sludge mixing tank. As shown in the graph of FIG. 1, even a small dosage of Ca(ClO)₂ (<0.1 g/g TSS) remarkably enhances the biodegradability of sludge in both aerobic and anerobic digestion reactors, leading to significantly improved cell lysis, organics release and methane recovery.

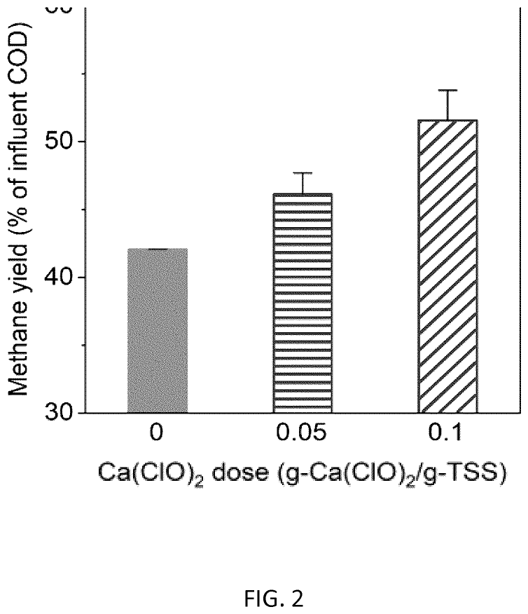

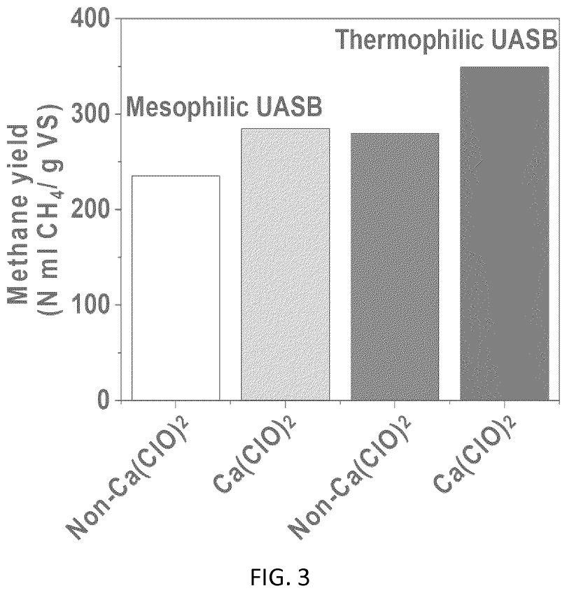

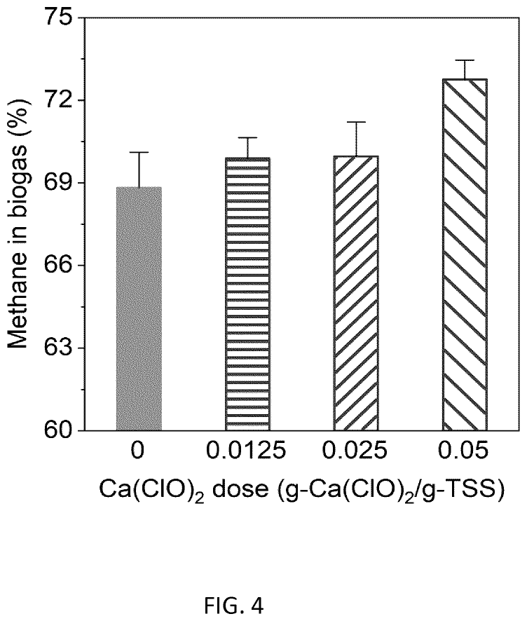

The inventive Ca(ClO)₂ pretreatment of sludge additionally enhances methane production, as shown in FIG. 2. According to embodiments, Ca(ClO)₂ pretreatment increases the methane production from 42.05% to 51.57% of the organics in WAS in batch reactors. Similar promotion is also observed in the continuously operated reactors under both mesophilic and thermophilic conditions, as shown in FIG. 3. Further, the carbon dioxide in the biogas is reduced and methane presence is increased by effective CO₂ sequestration, when the inventive Ca(ClO)₂ pretreatment is applied to wastewater sludge. Furthermore, as shown in FIG. 4, the methane content in biogas increases even with small dosages of the inventive Ca(ClO)₂ pretreatment of sludge.

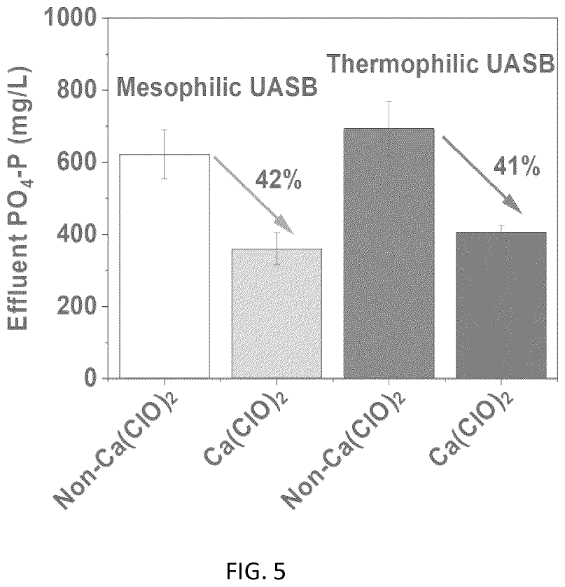

Furthermore, embodiments of the present invention reduce scaling of struvite (MgNH₃PO₄x6H₂O) in digesters, downstream pipes, pumps or centrifuges due to the addition of calcium ions, which leads to P fixation by forming insoluble CaP precipitates in digesters, which can then be applied as fertilizer. Removing P from aerobic and anaerobic digesters helps to minimize phosphate scaling in downstream pipes. As shown in FIG. 5, adding 0.05 g/g TSS of Ca(ClO)₂ achieves 42% and 41% reduction in phosphorus from the mesophilic and thermophilic UASB reactors, respectively, compared to the reactors fed with raw WAS.

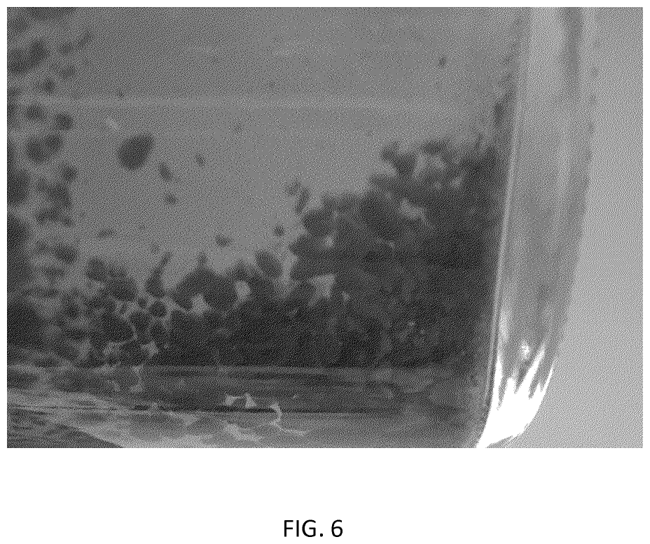

The present invention also provides bio-induced CaP precipitation through extracellular polymeric substances Ca complexation and enhanced localized CaP supersaturation. Extracellular polymeric substances (EPS), which are complex mixtures of polymers secreted by microorganisms, are often involved in the biomass aggregation (Liu et al., 2010; Ding et al., 2015). Proteins and polysaccharides account for 70-80% of the total amount of EPS organic matters (Dignac et al., 1998). It has been reported that some negatively charged functional groups in the EPS matrix, such as —OH, —COOH, —NH, —NH₂, and —SH, are responsible for the binding of polyvalent cations like Ca ions (Javanbakht et al., 2014; Liu et al., 2018; Yang et al., 2019; Deng et al., 2019). The binding of Ca ions with these relevant functional groups is likely to enrich the localized Ca content in the EPS matrix. The enriched Ca content leads to an elevated level of localized supersaturation of CaP species of interest (e.g., hydroxyapatite [HAP, Ca₅(PO₄)₃OH], tricalcium phosphate [TCP, Ca₃(PO₄)₂], octacalcium phosphate [OCP, Ca₈H₂(PO₄)₆·5H₂O], monetite [DCP, CaHPO₄], brushite [DCPD, CaHPO₄·2H₂O], amorphous calcium phosphate [ACP, Ca₃(PO₄)₂·xH₂O]), which eventually facilitates the precipitation of CaP minerals. Therefore, the biological environment created in the reactor is responsible for the bio-induced CaP precipitation. FIG. 6 is a photograph showing the formed granular sludge during the anaerobic digestion of sludge conditioned with 0.5 g Ca(ClO)₂/g TSS.

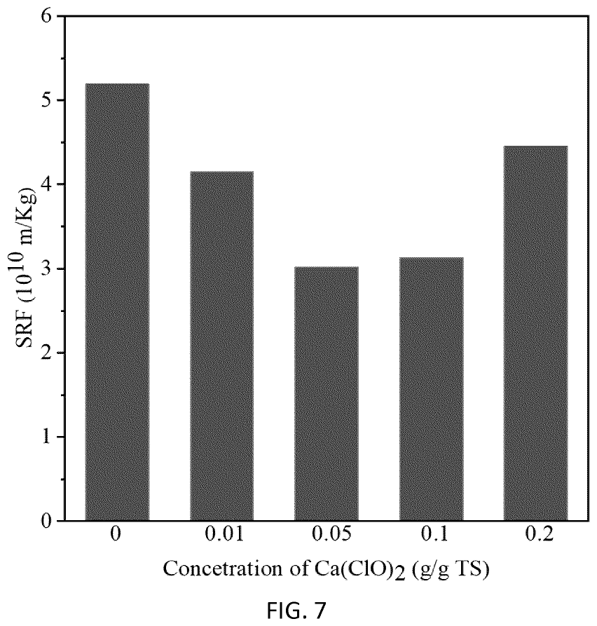

The present invention additionally provides improved sludge characteristics. That is, Ca²⁺ can also bind to the EPS and compress the electric double layer of sludge, thus transforming interfacial water into free water. The dewaterability of sludge is improved in this process by allowing sufficient time for the wastewater sludge to densify, further reducing the sludge disposal costs. The graph of FIG. 7 shows the specific resistance to filtration (SRF) of sludge after the inventive Ca(ClO)₂ pretreatment. According to further embodiments, the Ca(ClO)₂ pretreated sludge is reduced in volume by 60% as compared to non-pretreated sludge and it is sterilized, meaning the resulting treated sludge is not full of harmful bacteria.

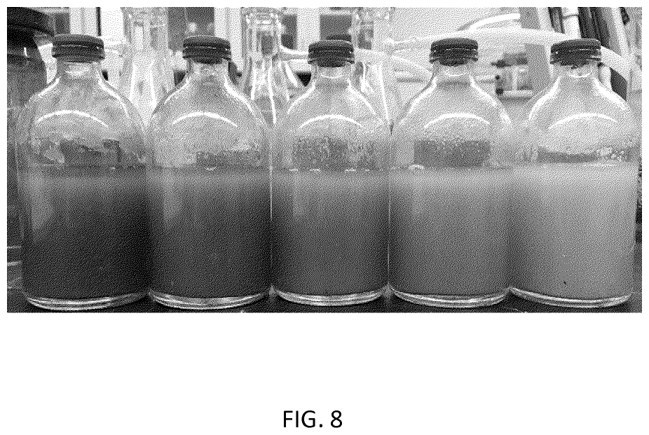

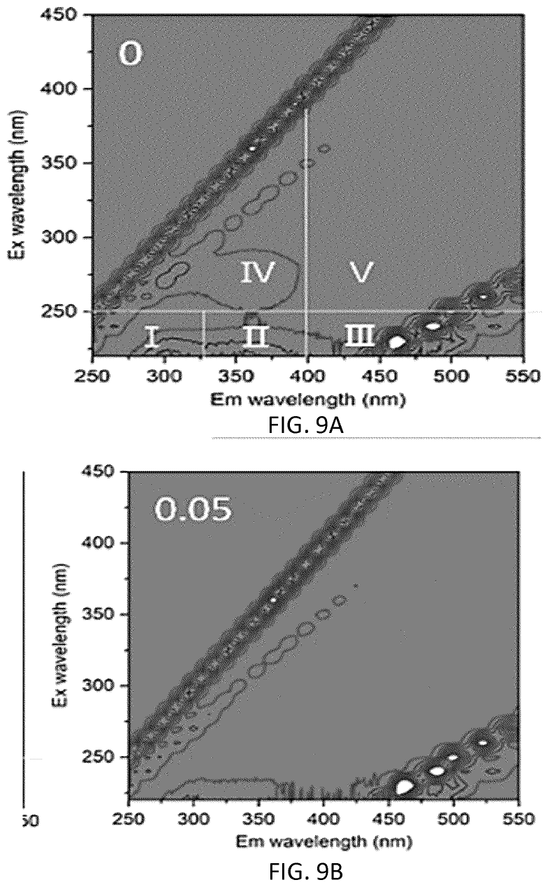

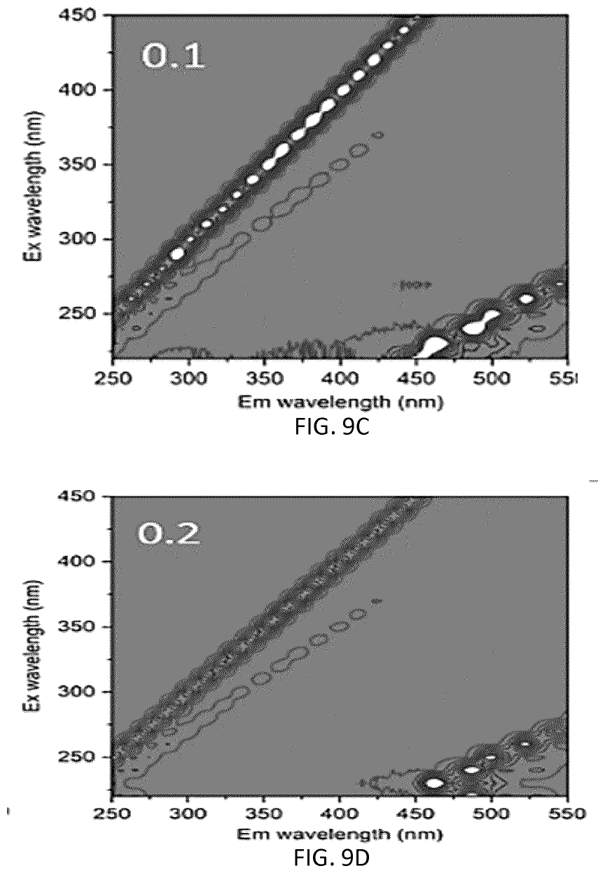

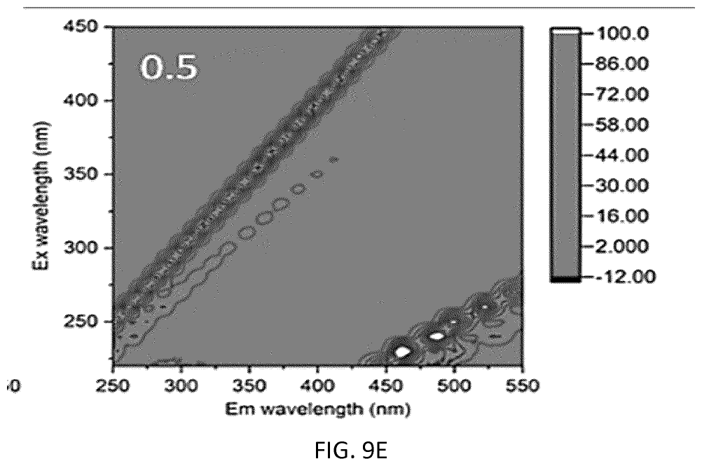

The present invention additionally provides improved recalcitrant organics degradation. That is, the presence of recalcitrant organics such as humic acid in sludge limits sludge biodegradation and reduces the microbial activities in digesters. As a strong oxidant, calcium hypochlorite addition enhances recalcitrant containments removal, thus improving the treatability of sludge. FIG. 8 is a photograph showing the decolouring effect of Ca(ClO)₂ on sludge with the dosages ranging from 0-0.5 g Ca(ClO)₂/g TSS (from left to right). FIGS. 9A-9E show fluorescence spectra of soluble microbial products in sludge after pretreatment with 0, 0.05, 0.1, 0.2, 0.5 g Ca(ClO)₂/g TSS Ca(ClO)₂, respectively.

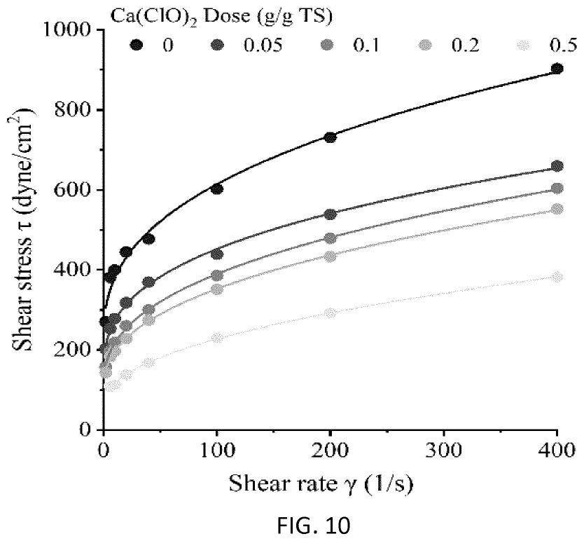

The present invention additionally provides improved dewaterability, fluidity, and foaming control. WAS is characterized as yield-psudoplastic fluid. The addition of Ca(ClO)₂ decreased the yield stress as well as the consistency index, indicating enhanced flow behavior by Ca(ClO)₂. FIG. 10 show a graph showing shear stress versus shear rate of WAS after pretreatment with each of 0, 0.05, 0.1, 0.2, 0.5 g Ca(ClO)₂/g TSS Ca(ClO)₂.

According to embodiments, the Ca(ClO)₂ pretreatment of the present invention is combined with other treatment technologies to improve the effectiveness. For example, when combined with anaerobic membrane bioreactors, the Ca(ClO)₂ pretreatment helps to reduce organic- and bio-fouling on membrane. Furthermore, when integrated with the electrochemical oxidation and thermal treatment process, the Ca(ClO)₂ pretreatment further improves sludge dewaterability, stabilization and phosphorus removal. Additionally, according to embodiments, the Ca(ClO)₂ pretreatment is combined with ultrasound treatment for water disinfection, given that ultrasound improves the utilization rate of Ca(ClO)₂.

According to embodiments, the Ca(ClO)₂ pretreatment can be applied to various recalcitrant wastes as an advanced oxidation process. For example, the Ca(ClO)₂ pretreatment can be applied to wastewater with high biomass or protein contents to improve digestibility, such as meat processing wastewater, livestock wastewater, dairy wastewater and slaughterhouse wastewater. Furthermore, the inventive Ca(ClO)₂ pretreatment can be applied to improve the treatability of sludge and wastewater with high toxicity (such as pharmaceutical wastewater, coking wastewater, textile wastewater, Shengli lignite, palm oil and olive mill wastewater) by degrading complex organics compounds and converting them to non-toxic and biodegradable components. Additionally, the Ca(ClO)₂ pretreatment can also be used for wastewater and sludge treatment for color reduction.

### REFERENCES

Deng, N., Stack, A. G., Weber, J., Cao, B., De Yoreo, J. J., Hu, Y., 2019. Organic-mineral interfacial chemistry drives heterogeneous nucleation of Sr-rich (Bax, Sr1−x)SO4 from undersaturated solution. PNAS 116 (27), 13221-13226.
Dignac, M.-F., Urbain, V., Rybacki, D., Bruchet, A., Snidaro, D., Scribe, P., 1998. Chemical description of extracellular polymers: implication on activated sludge floc structure. Water Sci. Technol. 38 (8-9), 45-53.
Ding, Z., Bourven, I., Guibaud, G., van Hullebusch, E. D., Panico, A., Pirozzi, F., Esposito, G., 2015. Role of extracellular polymeric substances (EPS) production in bioaggregation: application to wastewater treatment. Appl. Microbiol. Biotechnol. 99 (23), 9883-9905.
Javanbakht, V., Alavi, S. A., Zilouei, H., 2014. Mechanisms of heavy metal removal using microorganisms as biosorbent. Water Sci. Technol. 69 (9), 1775-1787.
Jenkins, D., Richard, M. G. and Daigger, G. T., 2003. Manual on the causes and control of activated sludge bulking, foaming, and other solids separation problems. Crc Press.
Liu, Y., Lv, W., Zhang, Z., Xia, S., 2018. Influencing characteristics of short-time aerobic digestion on spatial distribution and adsorption capacity of extracellular polymeric substances in waste activated sludge. RSC Adv. 8, 32172.
Liu, X., Sheng, G., Luo, H., Zhang, F., Yuan, S., Xu, J., Zeng, R., Wu, J., Yu, H., 2010. Contribution of extracellular polymeric substances (EPS) to the sludge aggregation. Environ. Sci. Technol. 44 (11), 4355-4360.
Yang, X., Wan, Y., Zheng, Y., He, F., Yu, Z., Huang, J., Wang, H., Ok, Y. S., Jiang, Y., Gao, B., 2019. Surface functional groups of carbon-based adsorbents and their roles in the removal of heavy metals from aqueous solutions: a critical review. Chem. Eng. J. 366 (15), 608-621.

Patent documents and publications mentioned in the specification are indicative of the levels of those skilled in the art to which the invention pertains. These documents and publications are incorporated herein by reference to the same extent as if each individual document or publication was specifically and individually incorporated herein by reference.

The foregoing description is illustrative of particular embodiments of the invention but is not meant to be a limitation upon the practice thereof. The following claims, including all equivalents thereof, are intended to define the scope of the invention.

1. A method of pretreating wastewater sludge, the method comprising:
applying an amount of at least 0.01 g/g TSS Ca(ClO)₂ to wastewater sludge to enhance digestibility of the sludge and reduce phosphorus concentration therein; and
allowing sufficient time for the wastewater sludge to densify to a treated sludge having a specific resistance to filtration (SRF) of 3 to 4 (10¹⁰ m/Kg).

2. The method of claim 1 further comprising subsequently subjecting the pretreated wastewater sludge to digestion.

3. The method of claim 2 wherein the digestion is anaerobic digestion or aerobic digestion.

4. (canceled)

5. The method of claim 2 wherein the digestion occurs in a batch reactor.

6. The method of claim 5 wherein the batch reactor is operated under mesophilic conditions or thermophilic conditions.

7. (canceled)

8. The method of claim 1 wherein the Ca(ClO)₂ is applied to the sludge in solid form or a powder.

9. (canceled)

10. The method of claim 1 wherein the Ca(ClO)₂ is applied as an emulsion.

11. The method of claim 10 wherein the emulsion is formed of Ca(ClO)₂ dissolved in water.

12. The method of claim 1 wherein the Ca(ClO)₂ is applied to the wastewater sludge when the wastewater sludge is located in transport pipes.

13. The method of claim 1 wherein the Ca(ClO)₂ is applied to the wastewater sludge when the wastewater sludge is located in a mixing tank.

14. The method of claim 1 wherein the amount of Ca(ClO)₂ applied is at least 0.1 g/g TSS.

15. The method of claim 1 wherein applying the amount of Ca(ClO)₂ additionally increases the methane production to at least 50% of organics present in the treated sludge.

16. The method of claim 1 further comprising forming insoluble CaP precipitates in digesters.

17. The method of claim 16 further comprising removing the insoluble CaP precipitates from the digesters for subsequent use as fertilizer.

18. The method of claim 1 wherein applying the amount of Ca(ClO)₂ additionally results in at least a 40% reduction in phosphorus present in the treated sludge or mitigates sludge foaming.

19. (canceled)

20. The method of claim 1 wherein the wastewater sludge has a high biomass or protein content.

21. The method of claim 1 wherein the wastewater sludge has a wastewater with high toxicity.

22. (canceled)

23. A composition of matter resulting from digestion of wastewater sludge pretreated according to the method of claim 1.

24. The composition of claim 23 wherein the composition of matter is sterilized or free of harmful bacteria.

25. (canceled)

26. Use of the composition of matter of claim 23 a fertilizer, fish food, or as a medium for growing mushrooms.

27. (canceled)

28. (canceled)
